(19) United States
(12) Patent Application Publication
(10) Pub. No.: US 2004/0076372 A1
(43) Pub. Date: Apr. 22, 2004

(54) Optical amplification structure with an integrated optical system and amplification housing integrating one such structure

(76) Inventors: Jacob Philipsen, Lyngby (DK); Denis Barbier, Grenoble (FR); Cedric Cassagnettes, St Martin D'Heres (FR); Serge Valette, Grenoble (FR)

Correspondence Address: Oblon Spivak McClelland, Maier & Neustadt, Fourth Floor, 1755 Jefferson Davis Highway, Arlington, VA, 22202, US

(21) Appl. No.: 10/469,930

(22) PCT Filed: Mar. 14, 2002
(86) PCT No.: PCT/FR02/00907

(30) Foreign Application Priority Data
Mar. 16, 2001 (FR) 01/03611

(51) Int. Cl. G02B 6/28

(52) U.S. Cl. 385/24; 359/341.1

(57) ABSTRACT

The invention relates to an optical amplifying structure capable of amplifying at least one light wave S, comprising in a substrate, for each wave to be amplified, an amplifying assembly composed of:

a first micro-waveguide (7) capable of receiving the light wave S to be amplified,

a second micro-waveguide (9) capable of receiving a pumping wave L,

a multiplexing device (11) associated with the first and second micro-waveguides, and capable of providing a coupled light wave composed of the wave S and the wave L,

an amplifying device (13) connected to an output of the multiplexing device and capable of amplifying the light wave S by at least partial absorption of the pumping wave L, the amplifying device being capable of providing at one output the amplified light wave S.

a third micro-waveguide (15) connected to the output of the amplifying device and capable of carrying the amplified light wave S, and

a demultiplexing device (19) associated with the third micro-waveguide and capable of demultiplexing the pumping wave L from the amplified wave S, and of providing on a fourth micro-waveguide (17) an amplified light wave S, purged of the pumping wave.

The structure of the invention is applied to all fields necessitating an amplification of a light wave and in particular in the field of optical telecommunications by optical fibres.

### TECHNICAL FIELD OF THE INVENTION

The present invention relates to an optical amplifying structure implemented in integrated optics, and an amplifying package integrating such a structure.

It is applicable in all fields requiring the amplification of a light wave and in particular in the field of optical telecommunications by optical fibres.

### STATE OF THE ART

FIG. 1 is a diagram showing the principle of a conventional amplification structure implemented in integrated optics.

To amplify a light wave, the optical amplifying structures at present implemented in integrated optics comprise two portions in which optical waveguides are formed.

An optical waveguide is composed of a central portion, generally termed core, and surrounding media situated all around the core and which may be the same as each other or different.

To permit confinement of the light in the core, the refractive index of the core medium should be different from, and in most cases greater than, those of the surrounding media. The waveguide may be a planar waveguide when the light is confined in one plane, or a micro-waveguide when the light is also confined laterally.

To simplify the description, the waveguide will be considered to be its central portion or core. Furthermore, all or part of the surrounding media will be termed “substrate”, with the understanding that when the waveguide is not buried or partially buried, one of the surrounding media may be outside the substrate and may for example be air.

According to the type of technique used, the substrate may be monolayer or multilayer.

Moreover, according to the applications, an optical waveguide in a substrate may be more or less buried in this substrate and may in particular comprise waveguide portions buried at variable depths. This is particularly the case in the technology of ion exchange in glass.

The first portion of the amplifying structure, referenced 1 in FIG. 1, receives as input on the one hand the light wave S of power Pₑ to be amplified, and on the other hand a pumping wave L generally coming from a laser source. The waves S and L are respectively carried in two micro-waveguides 5 and 4 to a coupler 3. The latter is embodied by the micro-waveguides 5 and 4 which are separated by a distance such that the wave S is injected into the micro-waveguide 4 carrying the wave L. At the output of the coupler 3, only the micro-waveguide 4 remains, which then carries the waves S and L. This first portion has only the role of coupling the two waves.

The second portion of the amplifying structure, referenced 2 in FIG. 1, receives the coupled waves S and L of the first portion as inputs to a micro-waveguide 6. This second portion has the purpose of amplifying the wave S of initial power Pₑ, based on the pumping wave L. The amplification in this second portion is effected in the micro-waveguide 6. The light wave S at the output of the micro-waveguide 6 then has a power Pₛ greater than the power Pₑ.

In the technology of ion exchange in glass, the first portion is, for example, silicate and the second portion is, for example, phosphate glass doped with erbium. These two portions are generally adhered together.

However, the output of these amplifying structures does not deliver solely the amplified light wave S. In fact, at the output of the micro-waveguide 6, the resulting light wave always includes a residual component of the pumping wave L. Although attenuated in the micro-waveguide 6, this residual component is capable of deteriorating the components or systems receiving the light wave leaving the amplifying structure.

### SUMMARY OF THE INVENTION AND BRIEF DESCRIPTION OF THE FIGURES

The present invention has as its object an optical amplifying structure implemented in integrated optics, not having the limitations and difficulties of the devices described hereinabove.

An object of the invention is in particular to provide an amplifying structure permitting maximum ejection of the pumping wave after amplification of the light wave, so as to obtain an amplified light wave as free as possible from any perturbations due to the pumping wave.

Another object of the invention is to implement this ejection of the pumping wave by integrated optics means formed on the same substrate as the remainder of the amplifying structure, to obtain a completely integrated, and thus compact, amplifying structure.

Another object of the invention is to integrate this amplifying structure into an amplifying package, permitting a compact and self-contained amplifying system to be offered.

More precisely, the amplifying structure of the invention permits at least one light wave S to be amplified, and comprises in a substrate, for each wave to be amplified, an amplifying assembly composed of:

a first micro-waveguide capable of receiving the light wave S to be amplified,

a second micro-waveguide capable of receiving a pumping wave L,

a multiplexing device associated with the first and second micro-waveguides, and capable of providing a light wave composed of the wave S and the wave L,

an amplifying device connected to an output of the multiplexing device and capable of amplifying the light wave S by at least partial absorption of the pumping wave L, the amplifying device being capable of providing at one output the amplified light wave S.

a third micro-waveguide connected to the output of the amplifying device and capable of carrying the amplified light wave S, and

a demultiplexing device associated with the third micro-waveguide and capable of demultiplexing the pumping wave L from the amplified wave S, and of providing as output on a fourth micro-waveguide an amplified light wave S, purged of the pumping wave, characterized in that the substrate is composed of a first portion termed passive and of a second portion termed active and in that the first, second, third and fourth micro-waveguides and also the multiplexing device and the demultiplexing device are in the passive portion, while the amplifying device is in the active portion.

By “passive portion” is understood a medium not capable of amplifying a light wave and, in contrast, by “active portion” is understood a medium capable of amplifying a light wave.

The use as substrate of two distinct portions, of which one is passive and the other is active, permits all the functions of the amplifying structure in integrated optics to be implemented, while if these functions had been implemented in a homogeneous substrate such as a wholly active substrate, certain passive functions such as a multiplexer could not have been implemented with good optical performance.

To permit the integration of the said functions, the form of the amplifying device is suitable for permitting its output to be on the same side as the output of the multiplexing device. In particular, the amplifying device forms a loop, or even a spiral, permitting the amplified wave to return into the passive portion.

By “purging of the pumping wave” is understood the elimination of all or part of the pumping wave. The less the amplified wave S is associated with residual components of the pumping wave as the output of the amplifying structure, the better are the characteristics of the structure.

The light wave S may be at one wavelength as well as at plural wavelengths λᵢ with i an integer from 1 to n, for example. In the specific field of telecommunications, the light wave permits information to be carried.

The pumping wave L is a light wave which can likewise be at one wavelength as well as at plural wavelengths λₚ with p an integer from 1 to k, for example; it brings energy into the structure so that the amplifying device may amplify the power of the light wave S.

According to an embodiment of the invention, in the technology of ion exchange in glass, the first portion is of silicate glass and the second portion is of phosphate glass doped with erbium, for example. These two portions are either adhered together or carried on a common support, but in all cases they form a single, although not homogeneous, substrate.

The different elements of the amplifying structure of the invention are implemented on the said substrate, preferably with the same technology, which permits a structure that is easy to implement, the elements of the structure being able to be implemented simultaneously or quasi simultaneously by the use of appropriate masks.

According to another embodiment, the first portion is of silica on silicon, and the second portion is doped phosphate glass.

According to an embodiment of the multiplexing device, this is chosen from among a multiplexer and a coupler.

According to an embodiment of the demultiplexing device, this is chosen from among a demultiplexer and a coupler.

According to an embodiment of the amplifying device, this is formed by a micro-waveguide capable of amplifying the light wave S by at least partial absorption of the pumping wave L. For this, the micro-waveguide generally comprises an appropriate doping of at least the core of the micro-waveguide.

The longer the micro-waveguide of the amplifying device, the greater the amplification. Preferably, to have as compact as possible an amplifying structure with good amplifying performance, the micro-waveguide forms a spiral with 1 to several turns.

Whatever the number of turns, they are preferably rolled up so as never to intersect.

According to another embodiment, the amplifying assembly furthermore comprises a first device for sampling a portion of the light wave S associated with the first micro-waveguide and/or a second device for sampling a portion of the light wave S associated with the fourth micro-waveguide, these sampling devices being capable of being respectively connected to a processing device. The first sampling device permits the extraction of a small percentage of the light wave S injected into the structure of the invention and the second sampling device permits the extraction of a small percentage of the amplified light wave S. These sampled percentages of the wave are transmitted to a processing device, for example a power detector and/or a control system.

By way of example, an output signal measuring and monitoring element (for example a photodiode) may be used, and if necessary the pumping power may be adjusted via, for example, an electronic feedback control.

The first and second sampling devices are preferably implemented in integrated optics on the same substrate as the remainder of the amplifying structure.

The first and/or second sampling device is implemented, for example, by a branching component, such as an asymmetric coupler or an asymmetric Y junction, capable of sampling a small fraction (for example, 1%) of the light signal.

When the amplifying structure of the invention is to amplify plural light waves Sⱼ with j an integer from 1 to m, the structure comprises m amplification assemblies as previously defined; these assemblies are implemented on the same substrate, and are interleaved one into another to form a compact structure.

In particular, when the amplifying device of each assembly is formed by a spiral micro-waveguide, the m spiral micro-waveguides of the structure form one spiral with m micro-waveguides.

According to a preferred embodiment, the amplifying device(s) of the structure of the invention are formed in the portion of the substrate termed the active portion, and the other elements of the structure are formed in the other portion of the substrate, termed the passive portion.

The invention likewise concerns an amplifying package grouping together the amplifying structure in integrated optics of the invention as previously defined, and components associated with this structure, this package thus permitting an amplifying system to be offered which can be compact and self-contained.

For each assembly amplifying a light wave S, the set of associated components comprises:

a first optical fibre optically connected to the first micro-waveguide, capable of carrying the light wave S to be amplified,

a second optical fibre connected to the fourth micro-waveguide, capable of carrying the amplified light wave S,

a source P of the pumping wave, optically connected to the second micro-waveguide.

Advantageously, this set of components furthermore comprises a first wave S processing device optically connected to the first sampling device when it exists, and/or a second wave S processing device optically connected to the second sampling device when it exists.

Optical connection can be performed directly between each processing device and the corresponding sampling device; in this case, the processing device is directly joined to the substrate of the amplifying structure, for example by adhesion. This joint may also be formed indirectly, via for example a fibre maintained between the two devices by mechanical elements such as ferrules.

Likewise, the optical connection between the pumping wave source and the second micro-waveguide is either direct, for example by adhesion of the source to the structure, or indirect via, for example, a fibre maintained between the source and the structure by mechanical elements such as ferrules.

According to an embodiment, the first and second fibres are respectively connected to the first and fourth micro-waveguides by connecting means chosen from among a ferrule or a V-block.

The connecting means of the second fibre furthermore comprise an optical insulator capable of preventing reflections which could perturb the light signal and introduce noise.

Other characteristics and advantages of the invention will become more apparent in the light of the following description. This description relates to embodiments which are given by way of explanation and without limitation. It furthermore refers to the accompanying drawings in which:

FIG. 1, already described, shows schematically a known amplifying structure,

FIG. 2 shows schematically an amplifying structure according to the invention, for a light wave S to be amplified,

FIG. 3 shows schematically an amplifying structure according to the invention, for plural light waves to be amplified,

FIG. 4 shows schematically a package integrating the amplifying structure of the invention and the associated components.

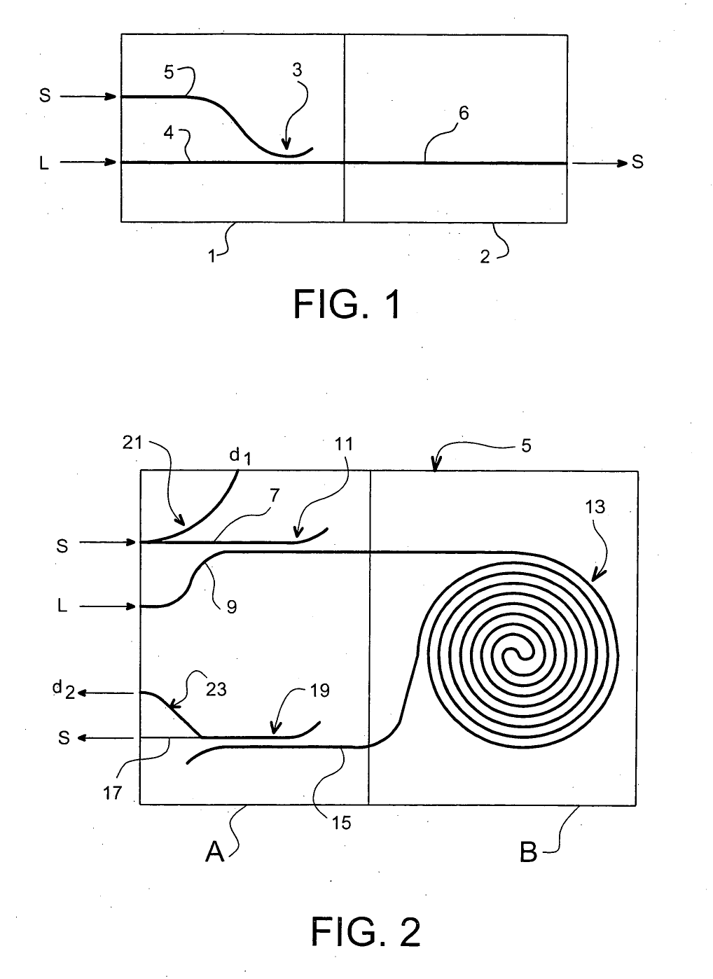

### DETAILED DESCRIPTION OF EMBODIMENTS

FIG. 2 shows schematically an amplifying structure according to the invention, for a light wave S to be amplified. In this diagram is shown a section of the substrate in which the structure is implemented, along a plane containing the different directions of propagation of light waves in the micro-waveguides, it being understood that according to the technologies used, these directions are of course not in practice necessarily contained in only one plane.

The amplifying structure shown in this figure permits one light wave S to be amplified and thus comprises a single amplifying assembly in a substrate 5. This assembly is composed of:

a first micro-waveguide 7 capable of receiving the light wave S to be amplified,

a second micro-waveguide 9 capable of receiving a pumping wave L,

a multiplexing device 11 associated with the first and second micro-waveguides, and capable of providing a light wave composed of the wave S and the wave L,

an amplifying device 13 connected to an output of the multiplexing device and capable of amplifying the light wave S and capable of providing on an output, the amplified light wave S,

a third micro-waveguide 15 connected to the output of the amplifying device and capable of carrying the amplified light wave S, and

a demultiplexing device 19 associated with the third micro-waveguide and capable of demultiplexing the pumping wave L from the amplified light wave S, and of providing on a fourth micro-waveguide an amplified light wave S purged of the pumping light wave.

In general, whatever the wavelength(s) λᵢ (generally comprised between 1530 and 1560 nm) of the light wave S, λᵢ is always greater than the wavelength(s) λₚ (generally close to 980 nm (by ±5 nm)) of the pumping wave.

Because of this, the evanescent wave associated with the propagation mode of the wave S has a lateral penetration distance greater than that of the pumping wave for given waveguide profiles.

The coupler 11 and the coupler 19 in this embodiment of the invention use this property to bring about respectively multiplexing and demultiplexing of the wave S and the wave L, in integrated optics.

Thus the coupler 11 is embodied by a portion of the micro-waveguides 9 and 7 which are mutually separated in the said portion by a sufficient distance da and over a sufficient length to permit only the wave S to be transferred from the guide 7 to the guide 9, without the wave L undergoing any modification of propagation in the coupler. This distance dₐ should be greater than the lateral penetration distance of the evanescent portion of the wave L in the guide 9 and less than the lateral penetration distance of the evanescent portion of the wave S in the guide 7, so that the wave S can be transferred over a reasonable length (for example, several mm). At the output of the coupler 11, in the example of this figure, there only remains the micro-waveguide 9 which is connected to the amplifying device 13 and in which the waves S and L are grouped together.

Similarly, the coupler 19 is formed by a portion of the micro-waveguides 15 and 17, which are separated from one another in the said portion by a sufficient distance d_{b} and over a sufficient length to permit the wave coming from the amplifying device, and comprising the amplified wave S and residues of the pumping wave L, to demultiplex the light wave S which passes into the micro-waveguide 17 from the pumping wave L which remains in the micro-waveguide 15. This distance d_{b} has to be greater than the lateral penetration distance of the evanescent portion of the wave L into the guide 15 and less than the lateral penetration distance of the evanescent portion of the wave S into the guide 15, so that the wave S may be transferred into the guide 17 over a reasonable length. At the output of the coupler 19, in the example of this figure, there remains only the micro-waveguide 17.

The amplifying device 13 shown in FIG. 2 is formed by a spiral micro-waveguide. The longer the spiral of the micro-waveguide, the better the amplifying performance of the device. The number of turns of the device depends on the dimension of the substrate in which the device is formed but also on the length of the micro-waveguide.

Advantageously, the structure may comprise a sampling device 21 for a portion of the light wave S introduced into the micro-waveguide 7.

Similarly, the structure can likewise comprise a sampling device 23 for a portion of the amplified light wave S carried by the micro-waveguide 19. These sampling devices 21, 23 are formed in this example by micro-waveguides respectively connected to the micro-waveguides 7 and 17 so as to form a Y junction. So as to sample only a small percentage of the light waves carried by the micro-waveguides 7 and 17, the micro-waveguides 21 and 23 are, for example, of smaller cross section than the micro-waveguides 7 and 17.

These sampling devices could likewise be implemented by a coupler having a short interaction length so that the sampling is small.

The light waves sampled by these sampling devices 21 and 23 are respectively referenced d₁ and d₂ and may be disposed at the output of the structure to be processed and to permit, for example, having a follow-up of the input power of the wave S and of the output power of this wave, and possibly to effect a regulation of these powers.

In this example, the amplification device 13 is formed in a portion of the substrate termed second portion B or active portion, and the other elements of the structure are formed in another portion of the substrate termed first portion A or passive portion. In the technology of ion exchange in glass, the first portion is silicate glass and the second portion is phosphate glass. These two portions are either adhered together or are joined to a common support, but in all cases they form a single substrate.

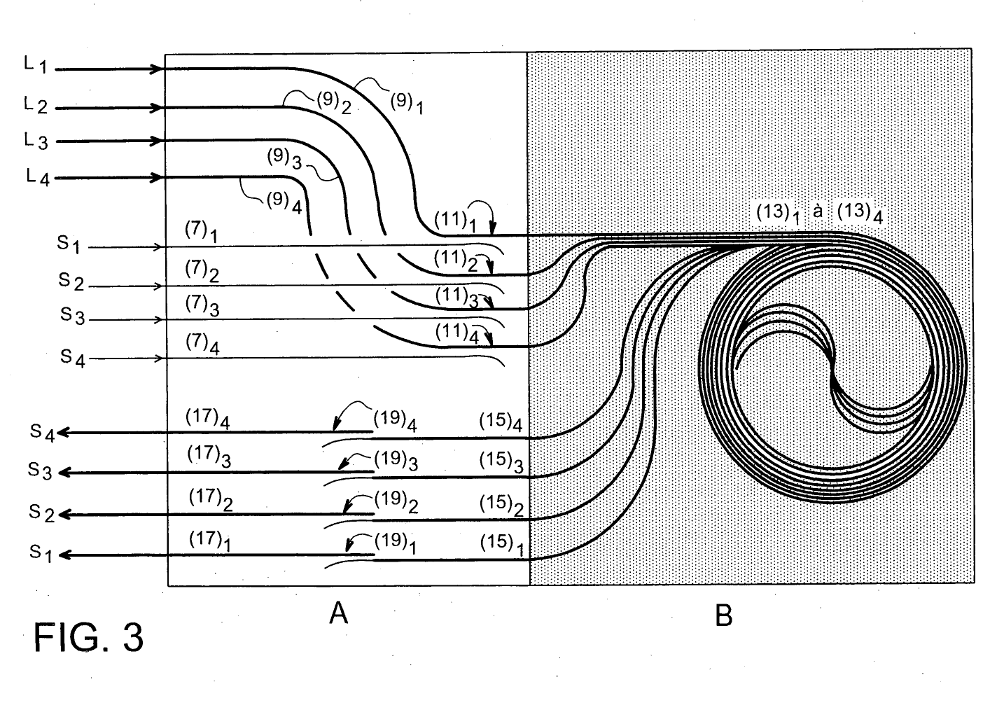

FIG. 3 shows schematically an amplifying structure according to the invention, for plural light waves to be amplified. In this example, four light waves S₁, S₂, S₃, S₄ are shown.

This structure thus comprises four amplifying assemblies implemented on the same substrate and mutually interleaved to form a compact structure. Each assembly is shown with a micro-waveguide (7)ⱼ, into which the light wave Sⱼ to be amplified is injected, a micro-waveguide (9)ⱼ into which is introduced the pumping wave Lⱼ, a coupler (11)ⱼ for grouping these two waves together, an amplifying device (13)ⱼ to amplify the wave Sⱼ, a micro-wave guide (15)ⱼ receiving the amplified wave Sⱼ, a demultiplexer (19)ⱼ for purging the amplified wave of the pumping wave, and a micro-waveguide (17)ⱼ for recovering the amplified, purged wave Sⱼ. In this example, j runs from 1 to 4.

It will be seen in particular in this example that the four amplifying devices of the structure are spiraled together, thus forming a spiral with four micro-waveguides in the active portion B of the substrate. The other elements are formed in the passive portion A of the substrate.

The different pumping waves Lⱼ may be derived, for example, from a matrix or linear array of laser photodiodes.

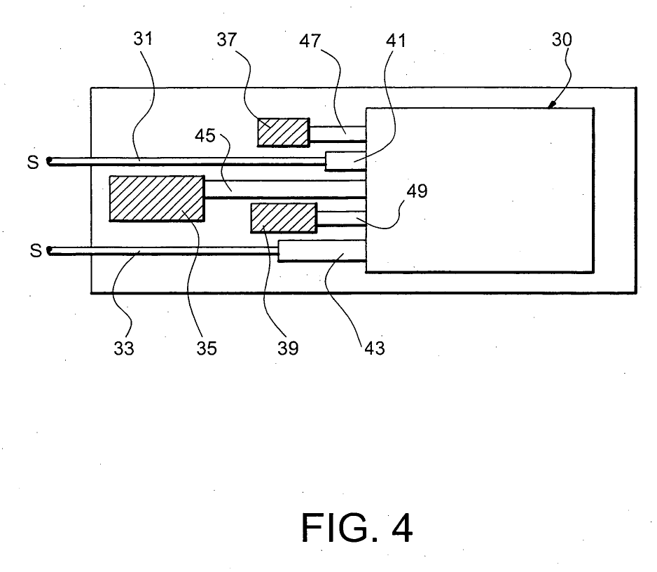

FIG. 4 shows schematically an amplifying package according to the invention. This package groups together the amplifying structure in integrated optics of the invention, referenced 30 without any detail of the elements composing it, and the components associated with this structure. To simplify the description, it is considered in this example that the structure integrated into the package has only a single amplifying assembly, but of course structures with plural assemblies can likewise be integrated.

The set of components associated with the structure in this example comprises:

an optical fibre 31 optically connected to the micro-waveguide 7 of the structure 30 and capable of carrying the light wave S to be amplified,

an optical fibre 33 optically connected to the micro-waveguide 17 of the structure 30 and capable of carrying the amplified light wave S,

a source 35 of the pumping wave L, optically connected to the micro-waveguide 9 of the structure 30,

a processing device 37 for the wave d₁ sampled from the wave S to be amplified, optically connected to the sampling device 21 of the structure,

a processing device 39 for the wave d₂ sampled from the amplified wave S, optically connected to the sampling device 23 of the structure.

The optical connection between the processing devices and the source on the one hand, and the structure on the other hand, may be performed directly, with a mechanical connection, for example by adhesion, which is performed between each of these components and the amplifying structure 30. This optical connection may also be formed indirectly, as shown in this figure, via mechanical and optical elements 45, 47, 49, for example a fibre maintained between the component and the structure by ferrules.

The fibres 31 and 33 are likewise respectively connected to the structure, for example by ferrules 41 and 43.

1. Optical amplifying structure capable of amplifying at least one light wave S, comprising in a substrate, for each wave to be amplified, an amplifying assembly composed of:
a first micro-waveguide (7) capable of receiving the light wave S to be amplified,
a second micro-waveguide (9) capable of receiving a pumping wave L,
a multiplexing device (11) associated with the first and second micro-waveguides, and capable of providing a light wave composed of the wave S and the wave L,
an amplifying device (13) connected to an output of the multiplexing device and capable of amplifying the light wave S by at least partial absorption of the pumping wave L, the amplifying device being capable of providing at one output the amplified light wave S.
a third micro-waveguide (15) connected to the output of the amplifying device and capable of carrying the amplified light wave S, and
a demultiplexing device (19) associated with the third micro-waveguide and capable of demultiplexing the pumping wave L from the amplified wave S, and of providing as output on a fourth micro-waveguide (17) an amplified light wave S, purged of the pumping wave, characterized in that the substrate is composed of a first portion termed passive and of a second portion termed active and in that the first, second, third and fourth micro-waveguides and also the multiplexing device and the demultiplexing device are in the passive portion, while the amplifying device is in the active portion.

2. Amplifying structure according to claim 1, characterized in that the multiplexing device is chosen from among a multiplexer and a coupler.

3. Amplifying structure according to claim 1, characterized in that the demultiplexing device is chosen from among a demultiplexer and a coupler.

4. Amplifying structure according to claim 1, characterized in that the multiplexing device (11) is formed by a portion of the first and second micro-waveguides (9, 7) which are separated from one another by a sufficient distance and over a sufficient length to permit only the light wave S to pass from the first micro-waveguide to the second micro-waveguide.

5. Amplifying structure according to claim 1, characterized in that the demultiplexing device (19) is formed by a portion of the third and fourth micro-waveguides (15 and 17) which are separated from one another by a sufficient distance and over a sufficient length to permit the light wave S to pass into the fourth micro-waveguide (17) and the pumping wave L to remain in the third micro-waveguide (15).

6. Amplifying structure according to claim 1, characterized in that the amplifying device comprises a micro-waveguide capable of amplifying the light wave S.

7. Amplifying structure according to claim 6, characterized in that the micro-waveguide of the amplifying device forms a spiral of one or more turns.

8. Amplifying structure according to claim 7, characterized in that the spiral is of plural turns, rolled up so as never to intersect.

9. Amplifying structure according to claim 1, characterized in that the amplifying assembly furthermore comprises a first sampling device (21) for a portion of the light wave S, associated with the first micro-waveguide, and/or a second sampling device (23) for a portion of the light wave S, associated with the fourth micro-waveguide.

10. Amplifying structure according to claim 9, characterized in that the first and/or second sampling device are chosen from among asymmetrical couplers or asymmetric Y junctions.

11. Amplifying structure according to any one of claims 1 to 10, characterized in that the passive portion is of silicate glass and the active portion is of doped phosphate glass.

12. Amplifying structure according to any one of claims 1 to 11, characterized in that the amplifying device has a shape permitting its output to be on the same side as the output of the multiplexing device.

13. Amplifying structure capable of amplifying plural light waves Sⱼ with j running from 1 to m, characterized in that it comprises at least m amplifying assemblies according to any one of the preceding claims.

14. Amplifying structure according to claim 10, characterized in that these assemblies are formed on the same substrate and are interleaved one into another.

15. Amplifying structure according to claim 13, characterized in that the amplifying device of each assembly is formed by a spiral micro-waveguide; the m spiral micro-waveguides of the structure form a spiral with m micro-waveguides.

16. Amplifying package, characterized in that it groups together the amplifying structure (30) according to any one of the preceding claims and components associated with the said structure, and the set of components associated with each amplifying assembly for a light wave S comprises:
a first optical fibre (31) optically connected to the first micro-waveguide, capable of carrying the light wave S to be amplified,
a second optical fibre (33) optically connected to the fourth micro-waveguide, capable of carrying the amplified light wave S,
a source (35) of the pumping wave L, optically connected to the second micro-waveguide.

17. Amplifying package according to claim 16, characterized in that the set of components furthermore comprises a first processing device (37) for the wave S, optically connected to the first sampling device and/or a second processing device (39) for the wave S optically connected to the second sampling device.

18. Amplifying package according to claim 17, characterized in that each treatment device is connected to the corresponding sampling device by optical and mechanical connecting means comprising a fibre and at least one ferrule.

19. Amplifying package according to claim 16, characterized in that the pumping wave source is connected to the second micro-waveguide by optical and mechanical connecting means comprising a fibre and at least one ferrule.

20. Amplifying package according to claim 16, characterized in that the first and second fibre are respectively connected to the first and fourth micro-waveguides by connecting means chosen from among a ferrule and a V-block.

21. Amplifying package according to claim 20, characterized in that the connecting means of the second fibre furthermore comprise an optical insulator.
